(19) United States
(12) Patent Application Publication
(10) Pub. No.: US 2006/0246203 A1
(43) Pub. Date: Nov. 2, 2006

(54) System for microorganism control

(76) Inventor: Virgil Macaluso, Independence, KS (US)

Correspondence Address: HOVEY WILLIAMS LLP, 2405 GRAND BLVD., SUITE 400, KANSAS CITY, MO, 64108, US

(21) Appl. No.: 11/116,710

(22) Filed: Apr. 28, 2005

(51) Int. Cl. A23L 1/36

(52) U.S. Cl. 426/632

(57) ABSTRACT

A method of infrared heat-processing of nuts (e.g., almonds, Brazil nuts, cashews, hazelnuts, macadamias, pecans, pine nuts, pistachios, walnuts and mixtures thereof) in order to reduce the microorganism level thereof is provided wherein the nuts are sequentially moisturized by application of water and then subjected to infrared radiation, preferably through a series of treatment cycles. Nut treatment apparatus (10) includes opposed banks of infrared heaters (38,40), with plural water application stations (48,50,52) along the length of the heater banks (38,40).

### BACKGROUND OF THE INVENTION

1. Field of the Invention

The present invention is broadly concerned with improved method and apparatus for treatment of nuts to control and reduce the level of potentially harmful microorganisms thereon. More particularly, the invention is concerned with such methods and apparatus wherein nuts are treated by application of water to the surface thereof followed by subjecting the nuts to infrared radiation sufficient to effect microorganism reduction; in preferred forms, the nuts are subjected to plural cycles of moisturization/infrared radiation.

2. Description of the Prior Art

U.S. Pat. No. 6,003,244 (incorporated by reference herein) describes improved tunnel-type infrared drying apparatus wherein a belt carrying a product to be dried is passed through an elongated drying tunnel equipt with a series of infrared heaters. If desired, the belt has associated agitators along the length thereof for agitating the product to ensure even infrared drying.

It is known that nut varieties such as almonds can carry significant quantities of harmful microorganisms such as Salmonella enteritidis. A large proportion of almonds are roasted prior to consumption thereof, and this technique is generally deemed adequate for control of S. enteritidis and other harmful bacteria. However, significant amounts of almonds are not subjected to roasting and are used as food additives and the like. In the case of these unroasted nuts, the microorganisms problem remains largely unresolved and there has been no truly efficient, cost-effective way of almond treatment.

### SUMMARY OF THE INVENTION

The present invention overcomes the problems outlined above and provides a method of treating nuts to reduce the level of microorganisms carried thereby, comprising the steps of first wetting the surface of the nuts and thereafter subjected them to infrared radiation sufficient to reduce the microorganism level. In preferred forms, the nuts are subjected to successive treatment cycles each involving application of water to the nuts with subsequent infrared heating. Advantageously, the method is carried out in an elongated tunnel-type heater equipped with upper and lower banks of infrared heaters and intermittent, axially spaced apart water application stations along the length of the apparatus.

In preferred processing, the nuts (e.g., almonds, peanuts, Brazil nuts, cashews, hazelnuts, macadamias, pecans, pine nuts, pistachios, walnuts and mixtures thereof) are wetted by spraying, fogging or misting of water and are heated so that the maximum temperature of the nuts during processing is at least about 140° F. and more preferably at least about 170° F. This water application step is contrasted with the direct application of steam. In the present invention, the water is preferably applied in the liquid state such as fine droplets formed by fogging, misting or spraying. In any case, the processing should reduce the level of at least one microorganism carried by the nuts by a 4 log factor (at least about 99.99%,) and more preferably by a 5 log factor (at least about 99.999%) as compared with the microorganism count of the nuts prior to processing. Also, in preferred practice the nuts should be treated so as to achieve a nut water activity of from about 0.5-0.62.

The present invention accomplishes a reduction in the level of microorganisms without the use of chemicals such as antimicrobial agents thereby eliminating the possibility that the nuts could become contaminated. The present invention also effects the reduction in microorganism level without the use of ionizing radiation such as X-rays and gamma rays thereby eliminating a radiation exposure concern expressed by a segment of the public. The present invention also accomplishes this stated goal without direct exposure of the nuts to steam. Although relatively benign, the exposure of the nuts to steam can damage the skin of the nut, whereas with the present invention such damage is avoided. Furthermore, the method according to the present invention does not cause the nuts to retain a significant amount of moisture.

Preferred processing operations also provide significant economic advantages over other forms of processing. Infrared radiation may be supplied though flameless, gas-fired catalytic heaters such as those described below or through electric infrared heaters. A supply of steam does not need to be provided thereby significantly reducing the utility costs associated with heater operation. The use of costly antimicrobial chemicals and expensive ionizing radiation equipment can also be avoided with the present invention.

The most preferred processing apparatus is in the form of an elongated tunnel-type heater comprising upper and lower opposed banks of infrared heaters, with a shiftable belt extending between the heater banks and operable to carry nuts to be processed. Additionally, at least one (and preferably a multiciplicity of) stations are provided along the length of the heater for deposition of water onto the nuts during passage through the tunnel-type heater device.

### BRIEF DESCRIPTION OF THE DRAWING

FIG. 1 is a schematic view of an infrared heater having a plurality of alternating heating and water application zones.

### DETAILED DESCRIPTION OF THE PREFERRED EMBODIMENT

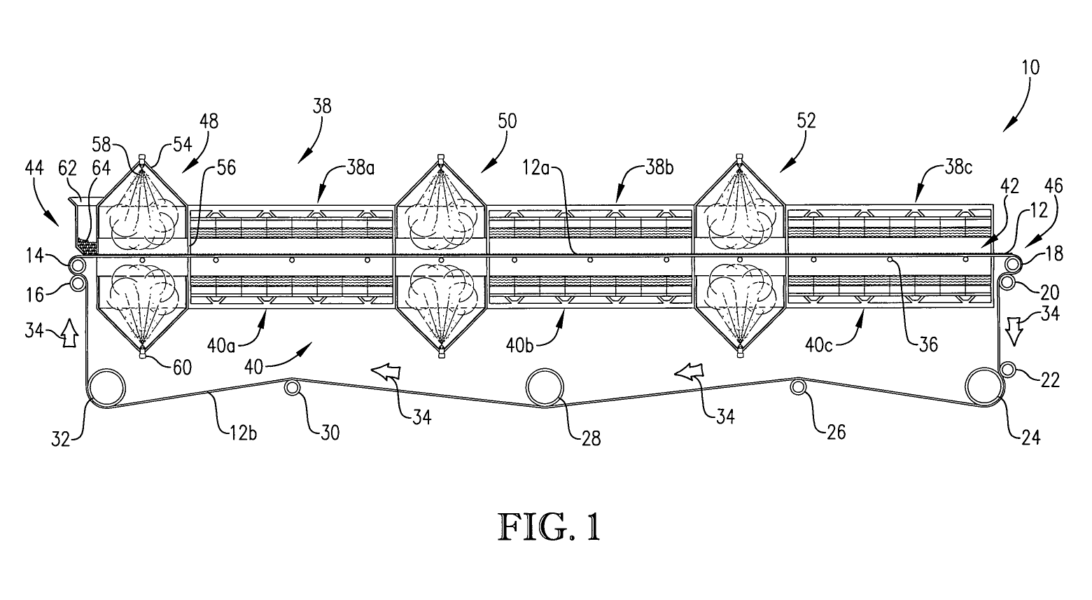

FIG. 1 schematically illustrates an infrared heater 10 useful in the invention. The heater 10 includes a continuous, shiftable, perforate belt 12 oriented to present an upper run 12a and a lower run 12b. The belt 12 is supported by nip rollers 14, 16, 18, 20 at respective ends of the upper run 12a, and also by lower idler rollers 22, 24, 26, 28, 30, 32. The nip roller sets 14, 16, 18, 20 are conventionally powered for moving the belt along the path indicated by arrows 34. As depicted, the upper run 12a of belt 12 is supported and maintained in a generally rectilinear fashion by means of transversely extending, axially spaced apart support rods 36.

The heater 10 includes an upper bank of infrared heaters 38 made up of axially spaced heater sections 38a, 38b, 38c. Also, a lower infrared heater bank 40 is provided, again comprising heater sections 40a, 40b, 40c. The heater banks 38, 40 are in direct opposed relationship so as to define an elongated passageway 42 extending along the length of the heater and defining an entry end 44 and an exit end 46. Infrared heaters 38, 40 can be flameless catalytic heaters such as those available from Catalytic Industrial Group, Independence, Kans. or electric heaters. The heaters preferably emit infrared radiation in a wavelength of about 2-7 microns. As illustrated, the upper run 12a of belt 12 extends along the entire length of passageway 42, approximately midway between the infrared heater banks 38, 40.

The overall heater 10 includes, in the illustrated embodiment, three water application stations 48, 50, 52. The station 48 is located adjacent passageway entry 44; the station 50 is between upper heater sections 38a, 38b and lower heater sections 40a, 40b; and station 52 is located between upper heater sections 38b, 38c and lower heater sections 40b, 40c. Each of the sections 48-52 is identical and includes a shroud or casing 54 having a central opening 56 therethrough. The upper and lower peaked ends of shroud 54 are equipped with downwardly and upwardly directed nozzles 58, 60 which are designed to provide a spray or mist of water onto the upper and lower surfaces of belt run 12a, respectively. The purpose of shroud 54 is to substantially contain the spray or mist of water applied to product passing through the respective stations 48-52.

Finally, it will be seen that the heater 10 has an inlet device 62 adjacent entry 44, for the purpose of depositing nuts 64 onto the upper surface of belt run 12a. Although not shown, the device 62 may be equipped with a rotary valve or other conventional expedient for depositing a relatively even layer of nuts onto run 12a during movement thereof.

In operation, nuts to be treated are deposited in device 62 and are in turn placed upon the upper surface of belt run 12a. As the belt 12 is moved, the deposited nuts pass in serial order through station 48, a first infrared heating zone defined by upper and lower heater sections 38a, 40a, station 50, a second infrared heating zone defined by upper and lower heater sections 38b, 40b, station 52, and finally through a terminal heating section defined by upper and lower heater sections 38c, 40c. Upper and lower heater sections 38, 40 are employed to ensure that substantially the entire surface of the nut is exposed to the infrared radiation and provide the greatest possible microorganism kill. The treated nuts fall under the influence of gravity from belt run 12a adjacent exit end 46, and are then conventionally collected on a cooling belt or bin (not shown). While it may be possible to utilize overhead heaters only, it will be necessary to turn the nuts over at some point during the process. This would require multiple passes though the heater with agitation of the nuts between passes to ensure that substantially all surfaces of the nut were exposed to the infrared radiation.

The goal of nut processing in apparatus 10 is to reduce the level of potentially harmful microorganisms carried by the as-received nuts. It has been found that sequential moisturization of the nuts followed by infrared heating through a series of cycles will very materially reduce the microorganism levels. Moisturization has been found to activate the microorganisms thereby placing them in a state most susceptible to being killed. As nuts generally contain very low amounts of internal moisture, microorganism activation is achieved by wetting the outer surface of the nuts prior to infrared radiation exposure. Generally speaking, it is desirable to process nuts with at least three cycles of moisturization and infrared heating, although such is not essential. In addition, at each moisturization station, water should be added at a level of from about 0.05-0.2 g of water per gram of nuts to be treated, and more preferably at 0.05-0.1 g of water per gram of nuts.

The infrared heaters should be operated so as to elevate the temperature of the nuts sufficiently to kill a substantial fraction of microorganisms on the nuts. In general, the nuts should exit the heater at a temperature of at least about 140° F., and more preferably at at least about 170° F. In terms of upper and lower temperatures, the nuts should exit the heater at a temperature of from about 140-250° F. and more preferably at about 170-230° F. The total residence time of the nuts within heater 10 should be on the order of from about 60-600 seconds and more preferably of from about 200-600 seconds. The total residence time may be equally divided between the individual heating sections, but this is not a critical factor.

The invention may be used for the treatment of virtually any variety of nut, although nuts selected from the group consisting of almonds, peanuts, Brazil nuts, cashews, hazelnuts, macadamias, pecans, pine nuts, pistachios, walnuts and mixtures thereof are preferred. The techniques of the invention are suitable for reducing or essentially eliminating potentially harmful microorganisms carried by the nuts, including without limitation Salmonella enteritidis, Escherichia coli, and Staphylococcus aureus.

The following example sets forth an illustrative method in accordance with the invention, describing a technique for control of microorganisms on nuts. It is to be understood, however, that this example is provided by way of illustration only, and nothing therein should be taken as a limitation upon the overall scope of the invention.

### EXAMPLE

In this example, almond samples were inoculated with Salmonella enteritidis and treated by sequentially heating and water-misting the inoculated almonds. Thereafter, the degree of microorganism kill was recorded and compared with control samples.

In particular, Salmonella enteritidis PT30 obtained from the National Food Laboratory was used in this study. The microorganism was maintained in phenol red agar media supplemented with sucrose (10.0 g/L) and sodium thiosulfate (0.3 g/L). Ferric ammonium citrate (0.5 g/L) was used as the recovery medium in all experiments. Stomaching was done using peptone water and serial dilutions were also done using peptone water.

Cultures were prepared by inoculation into 35 mL of tryptic soy broth followed by incubation at 35° C. well into the stationary phase (18 hours). The 18-hour culture was then used to inoculate seven TSA plates (100×15 mm) to produce a bacterial lawn after incubation for 24 hours at 35° C. Approximately seven plates were needed for 400 g almond samples. A 4 mL aliquot of 0.1% peptone was used to loosen the bacterial lawn with a sterile spreader. All of the inocula from all plates were pooled and mixed thoroughly.

Three 400 g almond samples were weighed into individual sterile bags. The almonds in each bag were then inoculated with 25 mL of the above-described inoculum by pipetting the inoculum solution over the almonds in the bags. The bags were closed and shaken by hand for 60 seconds. Sterile aluminum foil was placed on trays and filter paper placed on top of the foil. The almonds from the respective bags were then poured onto the trays, and the trays were stored for 24 hours at 24±1° C. in order to dry the almonds. Thereupon, eight 100 g almond test samples and one 25 g almond control sample were transferred into sterile bags and shipped to the processing site under refrigerated conditions. A bacterial count was taken on the control sample as of the day of inoculation, the day of plating, and the day of treatment of the eight test samples.

The eight 100 g inoculated samples (having an initial temperature of from about 68-71° F.) were pulse-heated in a flameless catalytic gas-fired infrared heater from top and bottom which was pre-heated for about 30 minutes before processing of the samples. Each 100 g sample was initially mixed with approximately 5 g of water prior to the first pulse and then again prior to each succeeding pulse. The infrared heater was operated for dwell times as follows: 150 seconds/7 pulses; 135 seconds/6 pulses; 100 seconds/4 pulses; 85 seconds/5 pulses; 105 seconds/5 pulses; and 110 seconds/5 pulses. Upon heating through the total residence time, the processed nuts had a temperature of from about 200-250° F. The heated nuts were then cooled to about 100° F. using an industrial fan for approximately 2.5 minutes. The inoculated, heat treated almonds were then placed in sterile bags and chilled immediately in ice. The bags were then placed in a refrigerator for one hour and were shipped under refrigerated conditions for laboratory analysis. All temperatures were measured using a hand-held infrared thermometer prior to entering the heater and after exiting from the heater.

The following tables set forth the parameters of the infrared heating tests using the eight 100 g inoculated samples, as well as results for water activity and moisture, and final reduction in bacterial count.

Test Parameters

TABLE 1.1
Test #1 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 69 | 50 | 230 | 32 |
| 2 | 148 | 20 | 250 | 28 |
| 3 | 160 | 15 | 230 | 45 |
| 4 | 140 | 15 | 245 | 45 |
| 5 | 145 | 15 | 210 | 32 |
| 6 | 150 | 20 | 240 | 37 |
| 7 | 140 | 15 | 220 | n/a |

TABLE 1.2
Test #2 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 68 | 50 | 220 | 21 |
| 2 | 150 | 20 | 250 | 28 |
| 3 | 168 | 15 | 200 | 33 |
| 4 | 140 | 15 | 230 | 34 |
| 5 | 140 | 15 | 200 | 45 |
| 6 | 145 | 20 | 220 | n/a |

TABLE 1.3
Test #3 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 70 | 50 | 250 | 25 |
| 2 | 140 | 20 | 230 | 32 |
| 3 | 140 | 15 | 240 | 22 |
| 4 | 150 | 15 | 220 | 37 |
| 5 | 150 | 15 | 230 | 24 |
| 6 | 135 | 20 | 250 | 22 |
| 7 | 150 | 15 | 240 | n/a |

TABLE 1.4
Test #4 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 69 | 50 | 240 | 13 |
| 2 | 170 | 20 | 260 | 17 |
| 3 | 170 | 15 | 230 | 18 |
| 4 | 170 | 15 | 245 | n/a |

TABLE 1.5
Test #5 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 69 | 50 | 250 | 10 |
| 2 | 168 | 20 | 230 | 14 |
| 3 | 170 | 15 | 210 | 20 |
| 4 | 150 | 15 | 250 | n/a |

TABLE 1.6
Test #6 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 71 | 40 | 190 | 17 |
| 2 | 140 | 15 | 190 | 18 |
| 3 | 150 | 10 | 190 | 19 |
| 4 | 140 | 10 | 220 | 18 |
| 5 | 135 | 10 | 200 | n/a |

TABLE 1.7
Test #7 Parameters

| | Temp | | | |
|---|---|---|---|---|
| | of almonds | Total residence | Temp of almonds | Time |
| Cycle | entering the | time in oven | exiting the Oven | between |
| Number | Oven (° F.) | (sec) | (° F.) | cycles (sec) |
| 1 | 70 | 45 | 230 | 150 |
| 2 | 150 | 15 | 220 | 14 |
| 3 | 140 | 15 | 230 | 19 |
| 4 | 150 | 15 | 190 | 21 |
| 5 | 140 | 15 | 220 | n/a |

TABLE 1.8
Test #8 Parameters

| | Temp of | | | |
|---|---|---|---|---|
| | almonds | Total residence | Temp of | Time |
| Cycle | entering the | time in oven | almonds exiting | between |
| Number | Oven (° F.) | (sec) | the Oven (° F.) | cycles (sec) |
| 1 | 72 | 45 | 220 | 23 |
| 2 | 155 | 15 | 220 | 19 |
| 3 | 170 | 15 | 230 | 20 |
| 4 | 140 | 20 | 220 | 22 |
| 5 | 150 | 15 | 210 | n/a |

The following Tables 2 and 3 set forth the bacterial count reduction in the treated almonds versus the control, and also the water activity and moisture results.

TABLE 2
Salmonella enteritidies PT30 Results

| | | | Log Reduction |
|---|---|---|---|
| | | Log | (compared to |
| Sample Description | CFU/g | Values* | Control) |
| Inoculated Control (Day 0) | 31310000000 | 8.5 | n/a |
| Inoculated Control (day of | 260000000 | 8.4 | n/a |
| experiment) | | | |
| Processed Samples (includes | | | |
| total exposure time to infrared | | | |
| heating) | | | |
| Test #1 (150 seconds) | 15 | 1.2 | 7.2 |
| Test #2 (135 seconds) | 10150 | 1.0 | 4.4 |
| Test #3 (150 seconds) | <10 | <1.0 | >7.4 |
| Test #4 (100 seconds) | 13150 | 4.1 | 4.3 |
| Test #5 (100 seconds) | 60 | 1.8 | 6.6 |
| Test #6 (85 seconds) | 11600 | 4.1 | 4.3 |
| Test #7 (105 seconds) | 340000 | 5.5 | 2.9 |
| Test #8 (110 seconds) | 120 | 2.1 | 6.3 |

*Log average CFU/g. Values were obtained by calculating the average CFU/g for each set and then taking the log of this number.

TABLE 3
Water Activity and Moisture Results

| | Water | Log Reduction |
|---|---|---|
| Sample Description | Activity | (compared to Control) |
| Uninoculated Control | 0.505 | 5.23 |
| Inoculated Control (Day 0) | 0.531 | n/a |
| Inoculated Control (day of | n/a | n/a |
| experiment) | | |
| Processed Samples (includes total | | |
| exposure time to infrared heating) | | |
| Test #1 (150 seconds) | 0.549 | n/a |
| Test #2 (135 seconds) | 0.657 | n/a |
| Test #3 (150 seconds) | 0.590 | n/a |
| Test #4 (100 seconds) | 0.583 | n/a |
| Test #5 (100 seconds) | 0.588 | n/a |
| Test #6 (85 seconds) | 0.642 | n/a |
| Test #7 (105 seconds) | 0.603 | n/a |
| Test #8 (110 seconds) | 0.615 | n/a |

I claim:

1. A method of treating nuts to reduce the level of microorganisms carried thereby, comprising the steps of applying water to the surface of the nuts and thereafter subjecting the nuts to infrared radiation sufficient to reduce said microorganism level.

2. The method of claim 1, including the steps of sequentially applying water to said nuts and subjecting the nuts to infrared radiation through a plurality of cycles.

3. The method of claim 2, there being at least three of said cycles.

4. The method of claim 1, including the step of subjecting the nuts to sufficient infrared radiation to elevate the temperature of the nuts to a level of at least about 140° F.

5. The method of claim 1, including the step of adding water to said nuts at a level of about 0.05-0.2 g of water per gram of nuts.

6. The method of claim 1, said nuts selected from the group consisting of almonds, peanuts, Brazil nuts, cashews, hazelnuts, macadamias, pecans, pine nuts, pistachios, walnuts and mixtures thereof.

7. The method of claim 1, including the step of reducing the level of at least one microorganism carried by said nuts by a factor of at least about 99.99% as compared with the microorganism count of said nuts prior to processing thereof.

8. The method of claim 1, said microorganism comprising Salmonella enteritidis.

9. The method of claim 1, including the step of passing said nuts through a heater comprising upper and lower banks of infrared heaters so as to simultaneously heat the upper and lower surfaces of said nuts.

10. The method of claim 9, including the step of placing said nuts on a perforate belt, and shifting said belt through said heater between said upper and lower banks of infrared heaters.

11. The method of claim 9, including the step of periodically depositing water onto said nuts during passage thereof through said heater.

12. The method of claim 1, including the step of subjecting said nuts to said infrared radiation for a period of from about 60-600 seconds.

13. The method of claim 1, including the step of subjecting said nuts to said infrared radiation to achieve a nut water activity of from about 0.52-0.62.

14. An apparatus for processing of nuts comprising:
an elongated tunnel-type heater comprising upper and lower opposed banks of infrared heaters;
a shiftable belt extending between said heater banks and operable to carry nuts to be processed through the heater; and
at least one station along the length of said heater operable to deposit water onto said nuts during passage thereof through the heater.

15. The apparatus of claim 14, including a plurality of said water-depositing stations spaced along the length of said heater.
